(19) United States
(12) Patent Application Publication
(10) Pub. No.: US 2013/0218581 A1
(43) Pub. Date: Aug. 22, 2013

(54) Stratifying patient populations through characterization of disease-driving signaling

(71) Applicants: Natalie Anne Leech Catlett, Medford, MA (US); David Alan Drubin, Boston, MA (US); Keith Owen Elliston, Concord, MA (US); Renee Marie Deehan Kenney, Cambridge, MA (US); Michael Paul Macoritto, Boston, MA (US)

(72) Inventors: Natalie Anne Leech Catlett, Medford, MA (US); David Alan Drubin, Boston, MA (US); Keith Owen Elliston, Concord, MA (US); Renee Marie Deehan Kenney, Cambridge, MA (US); Michael Paul Macoritto, Boston, MA (US)

(73) Assignee: Selventa, Inc., Cambridge, MA (US)

(21) Appl. No.: 13/456,491

(22) Filed: Apr. 26, 2012

Related U.S. Application Data
(60) Provisional application No. 61/479,217, filed on Apr. 26, 2011.

(51) Int. Cl. G06Q 50/22

(52) U.S. Cl. CPC G06Q 50/22; G06Q 30/0204
USPC 705/2

(57) ABSTRACT

A method of stratifying a set of disease-exhibiting patients prior to clinical trial of a target therapy begins by using a molecular footprint derived from a knowledgebase and other patient data to identify genes that are differentially expressed in a direction consistent with increase in the target activity. Therapeutic target “signaling strength” in individual patients of the set is then assessed using the genes identified and a strength algorithm. Based on their therapeutic target signaling strength, the set of disease-exhibiting patients are then stratified along a continuum. One or more gene expressions or other biomarkers may be specified for use in categorizing other disease-exhibiting patient populations. Alternative therapeutic targets are analyzed with respect to the likely non-responders, as evidenced by their differential signaling strength.

This application is based on Ser. No. 61/479,217, filed Apr. 26, 2011.

### TECHNICAL FIELD

This disclosure relates generally to stratifying patient populations through characterization of disease-driving signaling and, in particular, to identifying signaling driving responder and/or non-responder patient populations prior to clinical trial to facilitate development of alternative therapeutic targets and associated biomarkers.

### BACKGROUND OF THE RELATED ART

The current drug discovery paradigm is long, costly, and prone to failure. Though abilities to measure and analyze large amounts of complex data have increased significantly over the past decade and have provided valuable insight into the molecular mechanisms underlying disease, the industry as a whole is lagging in the production of new and innovative therapies. Multiple studies reference the extremely high failure rate (>80%), the length of time to develop (10-15 years through Phase III), and the high cost (at least $800 million) of new therapies. A substantial part of this cost is attributed to the cost of those projects (investigational drugs) that failed. Phase II, in which efficacy is usually first tested in patients, is the stage of drug development that has an extremely high failure rate. Across multiple therapeutic mechanisms, approximately 80% of novel projects that reach Phase II fail to demonstrate clinically-significant efficacy. Efficacy failures often occur from either of two major reasons: either the investigational agent did not achieve the required pharmacology, or the mechanism targeted by the investigational agent did not significantly contribute to the disease in this patient population. In either case, inadequate efficacy usually results in termination of a particular program.

To understand better the failure to translate technological advancements in the study of disease and drug mechanism in to more efficacious drugs, it is useful to examine related aspects of the existing drug discovery paradigm. As is well-known, drug discovery starts with preclinical research, in which the main goals are to identify candidate targets for a given disease area, develop compounds or antibodies that manipulate these targets, and assess their safety and efficacy in-vitro and in animal models. Candidate targets are most commonly identified through the mining of current, peer-reviewed literature on the disease and original research in animal models of that human disease. Frequently, the drug target is chosen based on the phenotype of a homogeneous group of genetically engineered animals. If a lead molecule can be identified to antagonize or agonize a biologic target, and if it is deemed safe and adequately efficacious in animal models, then the molecule may progress to clinical trials. Subsequently, most of these drug candidates fail, most often due to poor efficacy.

This high failure rate in Phase II should make one reconsider how biological targets are selected and in which patients they should be tested. Although animal models of disease may be useful in promoting understanding of physiology and pathophysiology, it is a more stringent requirement that these models also predict efficacy. In multiple different indications, animal models of disease have proven to be poor predictors of human response.

In addition to selection of the right mechanism, it is critical that the right patient be selected for targeted therapy treatment. Even a population of patients that appears to be phenotypically similar can exhibit distinct molecular disease profiles, e.g., due to differences in etiology, environmental factors, co-morbidities or genetics. A similar clinical diagnosis, therefore, may be the integrated result of multiple molecular disease-driving mechanisms.

More specifically, it has long been recognized that some patients may respond well to a particular intervention, whereas others may gain little or no benefit. As diseases are classically characterized by their phenotype and not always sub-categorized by the specific mechanisms or genotypes contributing to the phenotype, applying a focused molecular targeted therapy may not be effective in most patients, thus obscuring the benefit to the responder sub-population. Although one possibility for efficacy failure in a group of classically-defined patients could be that the investigated mechanism is altogether irrelevant to the disease, an alternative is that there are molecular sub-populations of patients, some of whom might be sensitive to a highly specific and directed therapy. Potentially valuable therapies are likely failing in some cases due to uninformed patient selection.

Thus, the patient population in a clinical trial for a targeted therapy often represents multiple disease subsets driven by different molecular mechanisms, only a subset of which will respond to a very specific, molecularly-focused treatment. Ideally, the responsive patient population within a disease group would be identified with the help of predictive biomarkers before enrollment in to a clinical trial. The current paradigm to develop such biomarkers depends on identifying factors that distinguish between responders and non-responders, and it thus relies on prior knowledge of clinical outcomes. Significant patient numbers to develop these correlative biomarkers are not available until after a Phase II or III clinical trial, at which point significant resources have been spent on a program that could fail due to a lack of efficacy.

There are several examples of how biomarkers are used to identify the likely-to-respond subjects, best exemplified in oncology. In such cases, distinct biomarkers that provide a specific patient stratification are currently packaged as companion diagnostics for targeted therapies, enabling the selection of patients that have a greater chance of responding to receive the drug. As a result, companion diagnostics are currently accepted and even mandated by regulatory agencies. Selecting the patient pool most likely to respond has proven beneficial for obtaining regulatory approval of effective drugs. Importantly, in the absence of the ability to select the right patients prior to enrollment, the efficacy of these drugs may have been masked by a cohort of patients that, while clinically similar, were heterogeneous with respect to disease etiology and pathogenesis, and potentially would have yielded a lackluster response to the molecularly-precise drug. As noted above, lackluster responses may often lead to termination of a program, and a potentially effective approach for some patients will be discarded.

As further background, it is also known in the art to identify a characteristic “signature” of measurements that results from one or more perturbations to a biological process, and subsequently to score the presence of that signature in additional data sets as a measure of specific activity of that process. Most previous work of this type involves identifying and scoring signatures that are correlated with a disease phenotype. These phenotype-derived signatures provide significant classification power, but the lack of a mechanistic or causal relationship between a single specific perturbation and the signature means that the signature may represent multiple distinct unknown perturbations that lead to the same disease phenotype. A number of studies, however, have focused instead on measuring causal signatures based on very specific upstream perturbations either performed directly in the system of interest, or from closely-related published data. Based on the simple, yet powerful, premise that modulation of cellular pathways and the components therein are associated with distinct signatures in downstream measureable entities, causally-derived signatures enable the “cause” of the signature to be identified with high specificity from the measured “effect.” These studies have demonstrated the great potential of applying a causal pathway scoring strategy to clinical problems, for example, by providing prognosis predictions in gastric cancer patients and indications of specific drug efficacy.

### BRIEF SUMMARY

The subject matter herein describes a new approach in the drug discovery and development process to stratify a patient population based on the biological signaling strength of a therapeutic target to determine likelihood of responsiveness to the therapeutic, and to develop predictive biomarkers to identify likely responders and non-responders (to the therapeutic) as early as the pre-clinical stage. This approach provides for a better in-depth understanding of human disease biology, improved success rate, and improved translatability from pre-clinical to clinical studies.

In one embodiment, a method of stratifying a set of disease-exhibiting patients prior to clinical trial of a target therapy begins by using a molecular footprint derived from a knowledgebase (e.g., of gene expression data) and other patient data to identify one or more genes that are differentially expressed in a direction consistent with increased biological activity of a target of a therapy. Therapeutic target “signaling strength” in individual patients of the set is then assessed using the one or more genes identified and a strength algorithm. Based on their therapeutic target signaling strength, the set of disease-exhibiting patients are then stratified along a continuum of therapeutic target signaling strength. A first subset (of one or more patients) on the continuum exhibit therapeutic target signaling strength of a first (e.g., “high value” or “low value”) range; thus, these patients are then defined as “likely responders” to the target therapy. A second subset of one or more patients on the continuum are distinct from the first subset and are associated with therapeutic target signaling strength of a second (e.g., “low value” or “high value”) range that differs from the first range; these patients are then defined as “likely non-responders” to the target therapy. Once responders and non-responders have been identified, gene expression or other data format biomarkers are developed, e.g., using standard algorithmic methodologies, thereby enabling future identification of responders and non-responders in new patient populations. If desired, at least one other therapeutic target is identified and investigated with respect to the likely non-responders.

In another embodiment, a computer-implemented method of pre-clinical trial patient classification includes several steps. The method begins by stratifying generally-classed, phenotypic disease-exhibiting patients on a continuum of therapeutic target signaling strength, wherein the signaling strength is a measure of fold change and a direction of genes in a gene signature, for the purpose of determining which patients are the most (or more) likely to respond to a specific therapeutic. Once likely responders and (as a result) likely non-responders are identified in this manner, one or more gene expression or other data format biomarkers are developed to enable similar identification (of likely responders/non-responders) in other patient populations. The foregoing has outlined some of the more pertinent features of the invention.

These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a schematic representation of a current drug discovery paradigm that is known in the art together with a representation of the approach of this disclosure;

FIG. 2 illustrates the patient stratification by signaling strength methodology and how it can be used to identify signaling driving both responder and non-responder patient populations;

FIG. 3 illustrates stratifying disease-exhibiting patients on a continuum of targeted therapy signaling strength;

FIG. 4 illustrates a use case of the methodology of this disclosure;

FIG. 5 illustrates a patient stratification in a first example scenario wherein the disclosed methodology is used to predict response to therapy by generating a gene expression classifier to identify patients most likely to respond to TNF-targeted therapy infliximab; and

FIG. 6 illustrates the result of applying a developed gene classifier to an independent diseased patient test set, illustrating its use as a biomarker.

### DETAILED DESCRIPTION

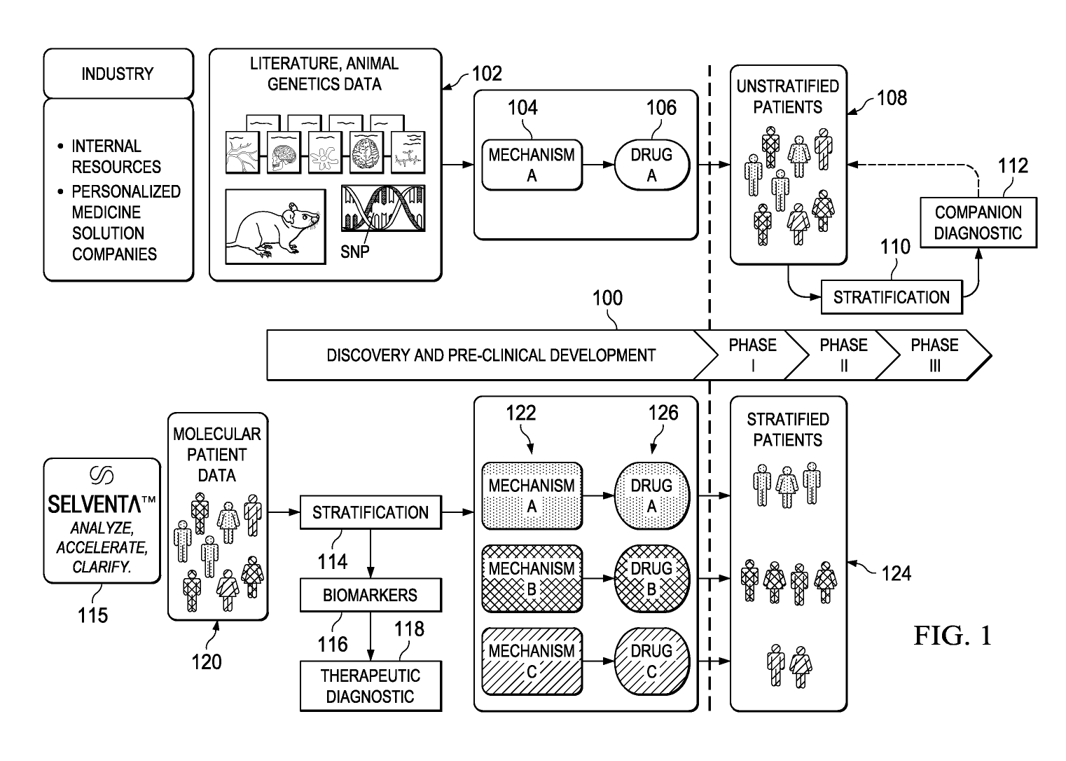

FIG. 1 represents a schematic representation of the current paradigm in the pharmaceutical industry versus the approach of this disclosure, which implements early (i.e. pre-clinical trial) application of signaling-driving mechanisms and biomarker identification. The top portion of the drawing illustrates the conventional approach and the associated timeline 100 that begins with discovery and pre-clinical development. As is well-known conventional drug discovery starts with preclinical research, in which the main goals are to identify candidate targets for a given disease area, develop compounds or antibodies that manipulate these targets, and assess their safety and efficacy in-vitro and in animal models. As indicated at 102, candidate targets are most commonly identified through the mining of current, peer-reviewed literature on the disease and original research in animal models of that human disease. From that work, a mechanism 104 is identified. Frequently, the drug target is chosen based on the phenotype of a homogeneous group of genetically engineered animals. If a lead molecule can be identified to antagonize or agonize a biologic target, and if it is deemed safe and adequately efficacious in animal models, then the molecule (in the form of drug 106) may progress to clinical trials. Beginning with Phase 1 trials, the drug is provided to patients, but these patients are not stratified 108. Only after Phase II trials are on-going are complete is stratification 110 then implemented. Ideally, the responsive patient population within a disease group would be identified with the help of predictive biomarkers before enrollment in the clinical trial. The current paradigm to develop such biomarkers depends on identifying factors that distinguish between responders and non-responders, and (according to the prior art) it thus relies on prior knowledge of clinical outcomes. As the top portion of FIG. 1 indicates, significant patient numbers to develop these correlative biomarkers are not available until after a Phase II or III clinical trial. After stratification 110, distinct biomarkers that provide a specific patient stratification are then packaged as companion diagnostics 112 for targeted therapies, enabling the future selection of patients that have a greater chance of responding to receive the drug. Such companion diagnostics are currently accepted and even mandated by regulatory agencies.

As described above, this known approach is highly inefficient due to efficacy failures during costly and lengthy clinical evaluation. As noted, efficacy failures typically occur because the drug (i.e., the investigational agent) does not achieve the required pharmacology, or the mechanism 104 targeted by the drug does not significantly contribute to the disease in the particular patient population tested.

This problem is addressed by the methodology herein and, in particular, by proactively stratifying patients as early as possible in the drug development paradigm and, most optimally, prior to initial clinical trial. This proactive approach to patient stratification provides significant advantages as compared to the current use of patient stratification as a reactive solution to the problems of patient heterogeneity and drug resistance wherein markers of effective response are assessed only subsequently to extensive characterization of clinical trial data.

As seen in the bottom portion of FIG. 1, and using the approach herein, stratification 114 occurs during the discovery and pre-clinical development, as opposed to during the clinical trial phase. The early stratification in this manner also enables biomarkers 116 that identify likely responders for a targeted therapeutic within a population of patients (including across multiple disease areas) to be predicted, such that one or more therapeutic diagnostics 118 can then be developed. As will be described in more detail below, the inventive strategy relies upon the hypothesis and recognition that patient groups that exhibit either high or low levels of target mechanism signaling strength are more likely to respond to treatment with a given targeted therapeutic. The adjectives “high” and “low” are relative terms with respect to one another and their relative meanings may be reversed such that, depending on the scenario or use case, a high (or low) value therapeutic target signaling strength as the case may be may indicate either a “likely” responder or “non-likely” responder, or vice versa. To that end, preferably the approach herein begins with molecular profiling data 120, such as whole genome expression data, from diseased patients at baseline. This information typically is obtained through public data sources and databases. In addition to the molecular profiling data 120, the technique also uses or exploits information from a causal knowledgebase 115 that has stored therein gene expression signatures of a large number of biological perturbations (e.g., from over a large number of peer-reviewed publications). Preferably, the knowledge base includes data from which can be identified a number of mechanisms 122 (and there may be many thousands) that represent a potential driver of disease. The perturbation (or “signaling strength”) of each such mechanism can be assessed in individual patients within a population. For example, a gene expression signature for MAPK13 activity, based on prior knowledge, is extracted from the knowledge base. Fold changes in gene expression are calculated for each patient as compared to a common baseline, e.g., a non-disease population or a median patient, and a strength assessment algorithm (e.g., that takes a hyper-geometric mean of the fold change for each gene in the signature of interest) is applied. One such technique is described in U.S. Publication No. 2012/0030162, the disclosure of which is incorporated herein by reference.

Significantly, and with reference back to FIG. 1, this assessment is a quantitative value that enables the group of patients to be stratified by their levels of signaling strength for each of the mechanisms. Patient stratification 114 by signal strength allows identification of those mechanisms 122 that are most strongly or weakly activated in different subsets of heterogeneous patients, and it can be used in this way to identify subsets most likely to respond to treatment. The result of this process is a set of stratified patients 124.

Significantly, and in contrast to the prior art, no a priori knowledge of treatment outcomes is required to facilitate the patient stratification which, as described above, is effected instead by using therapeutic target signaling strength. Through this early consideration of potential pathways contributing to disease, patients with a generally-classed, phenotypic disease preferably are sub-segmented or stratified into more refined groups. This approach enables investigational therapies (e.g., one or more drugs 126), as well as biomarkers 116 of response, to be targeted more appropriately as compared to the prior art.

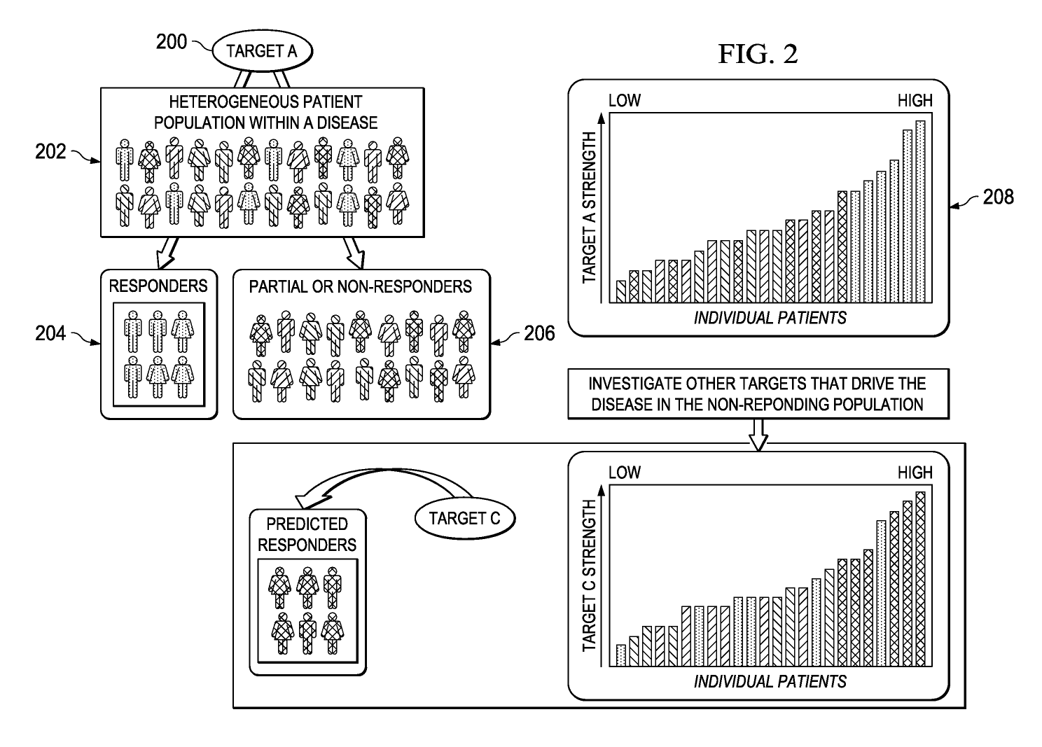

FIG. 2 illustrates how signaling is used to stratify patients in a preferred embodiment. As noted above, and according to this disclosure, patients are stratified by the strength of a therapeutic target mechanism's signaling, and this signaling is then considered a surrogate indicator of response to treatment. Continuing with the example scenario from FIG. 1, target mechanism 200 is applied with respect to a heterogeneous patient population within a disease 202. Then, one or more “classifiers” are developed or generated to determine whether a patient is or should be classified in a first category 204 as a “likely responder,” or in a second category 206 as a “likely non-responder.” A classifier acts functionally as a biomarker for treatment response. The likely non-responder category may also include “partial” non-responders. Thus, the labels “responder” and “non-responder” should not be taken to limit the scope of this disclosure, and whether particular individuals fall into particular categories typically depends on the disease-target pair under study. In either case, and as has been described, preferably the characterization or categorization of a particular individual in the population is based on the individual signaling levels.

As used herein, a “classifier” typically is a set of measurable analytes including, without limitation, RNA expression levels, protein abundance levels, and phospho-protein abundance levels, which can be used to stratify patients into mechanistic biological signaling categories that may be predictive of treatment response and thus used as a biomarker for treatment. Patients with high versus low (in this example) signaling strength (as represented in graph 208) may be predicted to be the responders. By applying a strength algorithm to gene signatures that represent the target mechanism, patients are stratified by their respective levels of pathway activation. These gene signatures typically range in size (e.g., from a few to over a thousand genes) and are derived from multiple tissues. With respect to development of content for a biomarker, it is useful to identify a small, targeted number of genes to be measured. Therefore, in the preferred approach, classifiers predict whether patients exhibit “high” or “low” levels (or, more generally, some measurable differential) of target pathway activation thereby to identify patients in the “likely responder” and “likely non-responder” populations and thus act as biomarkers for treatment response.

As also seen in FIG. 2, the population of likely non-responders may be analyzed further to identify the disease driving mechanisms active in these patients, and to inform researchers of other potential therapeutics (e.g., in this case, target C) that may be of value for these patients. Thus, according to this disclosure, the signaling strength techniques are used to identify patients who are expected to respond to a given therapy, and they can be used to identify possible alternative targets in patients who are not expected to respond to that therapy. In the former case, a therapeutic is available that works only in a subset of patients and that subset is identified beforehand; in the latter case, a therapeutic is available that works on in a subset of patients, and one or more therapeutic disease drivers (and thus therapeutic targets) are then identified for the remainder of the patients (the non-responders). By combining these approaches, and given data on a group of patients, this disclosure further contemplates identifying a priori therapeutic targets, and then stratifying by those targets.

Generalizing, the methodology typically has several phases. In a first phase, a molecular footprint (a “mechanism”), preferably based on gene expression data, is generated as follows. A large knowledgebase of gene expression data initially is curated and thus “constrained” to identify gene expression changes regulated by a therapeutic target (e.g., a particular human growth factor) in relevant experimental contexts. Thereafter, disease-relevant gene expression is identified, preferably by assessing one or more genes in vivo in the disease of interest using patient data. Without intending to be limiting, the knowledgebase may be a commercial system of cause-and-effect relationships, such as available from Selventa, Inc., of Cambridge, Mass., and the patient data may be mined from available Internet-accessible data sources. In this step, the patient data sets are analyzed to identify one or more genes that are differentially expressed and can be regulated by a therapeutic target. Some genes may be filtered out and are not included in (or otherwise removed from) the footprint.

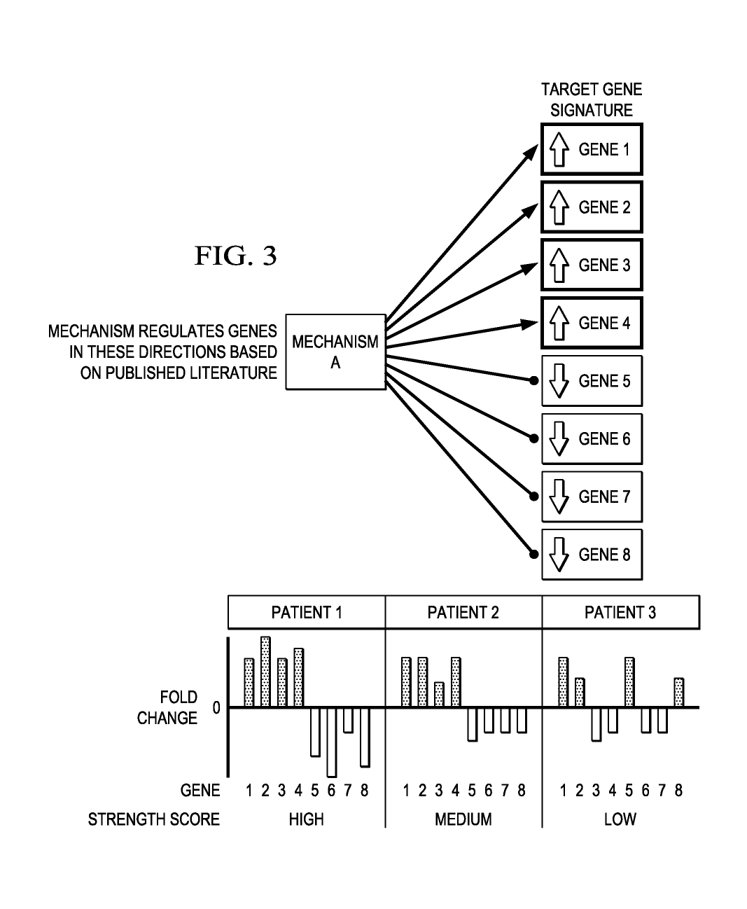

A next phase then stratifies disease-exhibiting patients on a continuum of the therapeutic target's signaling strength. In this phase, therapeutic target signaling strength is assessed in individual patients using the molecular footprint (generated as a result of constraining the knowledgebase and determining the expression of genes in vivo in the disease of interest using patient data). Preferably, strength is based on fold change and the direction of genes in the footprint. More specifically, the strength metric is calculated on a target gene signature using a strength algorithm including, without limitation, those identified as Strength, MASS and TCS in U.S. Publication No. 2012/0030162, the relevant disclosure of which is incorporated herein by reference. As described there, the strength algorithm (and there are several disclosed) calculates the geometric mean of the fold changes in the gene signature. Then, a quantitative value is assigned to each patient for their level of signaling specific to the therapeutic target. In particular, the relative signaling strength of a target network in each patient of a population is assessed, and then patients are then stratified on a continuum of network strength. This operation is illustrated in FIG. 3. This top portion of the drawing illustrates the therapeutic target (mechanism A) and how the mechanism regulates gene expressions and generates the patient stratification. The bottom portion of the drawing illustrates the resulting patient stratification (disease patients stratified on a continuum of therapeutic target signaling strength). Then, patients with the highest signaling strength (or, more generally, a differential range of strength), are then designated likely responders. Conversely, patients with the lowest signaling strength (or, more generally, a differential range of strength) are designated likely non-responders or (depending on where they lie on the continuum) as “partial” responders. In a representative embodiment, the highest 20% are classified as likely responders, although this is not meant to be limiting, as other values and ranges (identifying likely responders, likely non-responders, partial responders, and the like) may be used. From this information, a gene or other data type-based classifiers are developed using standard algorithmic methodologies, which can themselves act as, or be used to identify, biomarkers, thereby enabling future identification of responders and non-responders in new diseased patient populations.

A next phase of the method, which is optional, involves identifying the one or more mechanisms that exhibit differential strength between likely responder and non-responder patient populations. Mechanisms that represent strong signaling in non-responders may represent alternative disease drivers and thus may be candidates for therapeutic targets. Once again, the activation levels (strength) are assessed for each patient, preferably against data derived once again from the knowledgebase (or other data sources). Preferably, in this phase multiple patient data sets are analyzed to identify molecular mechanisms whose pattern of activation consistently differentiates between likely responder and non-responders and that comprise a therapeutic target-associated complex signaling pathway as represented in the knowledgebase.

Finally, the mechanisms identified in the prior phase (i.e. those that differentiate likely responders and non-responders) are then analyzed in the context of disease-signaling pathways. In this phase, which also is optional, preferably the knowledgebase is once again constrained to a disease model (e.g., tumor angiogenesis for gastric cancer). This operation generates a literature-based model that can then be used to identify likely response and resistance mechanisms and markers. In particular, mechanisms identified in the prior phase are then “painted” on the model that is based on literature associations in relevant contexts (as derived from the knowledgebase). The resulting fine-tuned model exhibits relevant dependent and compensatory pathways in patients to enable identification of one or more: (i) mechanisms of response, (ii) mechanisms of non-response, (iii) and therapeutic targets.

Thus, in the latter (optional) phases, patient subsets stratified using the footprint are characterized to determine if the therapeutic target signaling is effectively resolved, and to identify other targets or biomarkers. This enables all mechanisms in the knowledgebase to be tested for stratification of high value responders. Other mechanisms that are modulated in a similar pattern are identified, and biological relevance of correlated mechanisms may be investigated.

The following are additional implementation details for a particular use case.

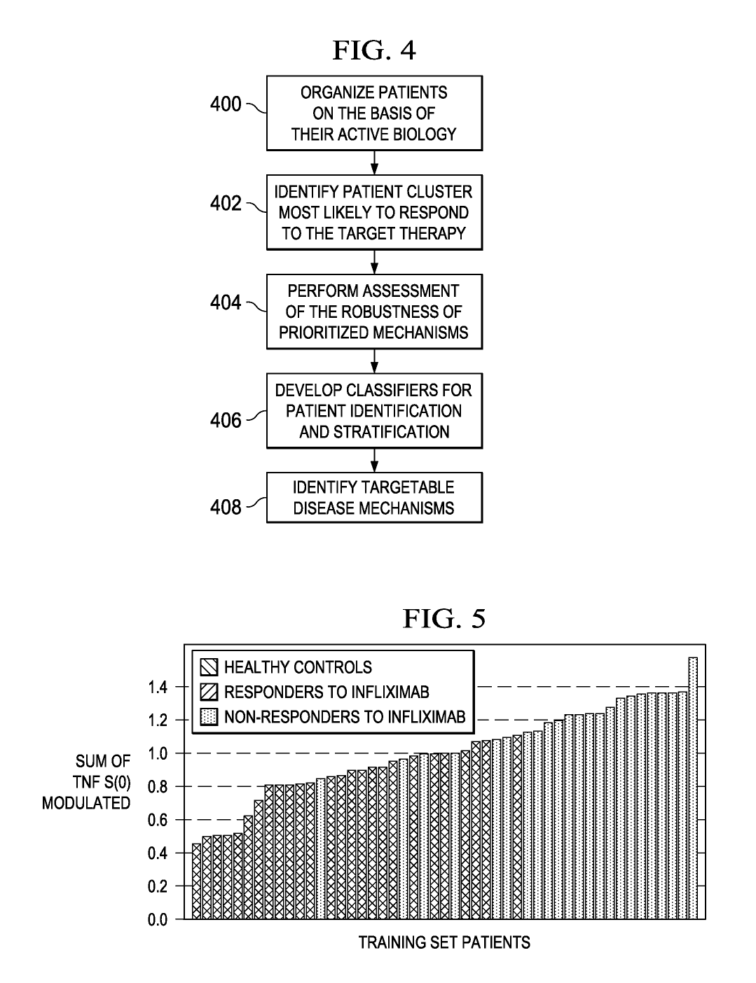

In a first embodiment, as illustrated in the process flow in FIG. 4, patients are first organized on the basis of their active biology. This is step 400. At step 402, a patient cluster most likely to respond to a desired therapy (if the therapeutic outcome is already known) is identified. Then, at step 404, an assessment is performed of the robustness of prioritized mechanisms, preferably based on an independent test set. Step 404 is optional. At step 406, one or more classifiers are then developed for future patient identification and stratification. The method then continues at step 408 to identify targetable disease mechanisms. This step also is optional.

The following provides additional details of each step. Step 400 typically involves a number of sub-steps. First, and as described in U.S. Publication No. 2012/0030162, a “Network Perturbation Amplitude” (NPA) is calculated for all hypotheses for the data set. Preferably, and as described therein, an NPA score combines fold differences of a subset of genes within the data set that underlie a molecular mechanism. Then, unsupervised clustering on all patients is then performed, preferably based on the union of NPA scores for individual diseased patients either versus a median patient centroid or versus healthy samples (i.e. “normals”). Thereafter, an identification is made of the sub-populations of patients that cluster together based on their biology as represented by their associated relatively high and low NPA scores for individual molecular mechanisms. This completes step 400.

At step 402, the process identifies which patient cluster (created in step 400) is most likely to respond to a desired therapy if therapy outcome is not already known. Although not meant to be limiting, this identification may proceed as follows. Using known knowledge about the disease or therapy to select an individual or group of NPA scores that identify which patient sub-group is most likely to respond (or not) to the desired therapy, the patient sub-population(s) that have a relatively higher NPA score are then identified and designated as probable non-responders. Thus, for example, if the desired therapy is an anti-TNF biologic and scientific literature indicates that patients with high TNF activity levels do not respond to the biologic, the patient sub-population(s) that have a relatively higher TNF NPA score are designated as probable non-responders in this step.

Step 404 typically involves calculating NPA score and significance for an independent set of patients with the same disease and treatment. The reproducibility of the results from the training set is then assessed. Molecular mechanisms that significantly differentiate responders from non-responders in the test set may then be prioritized as an optional step.

Step 406 involves developing classifiers for patient identification and stratification. Preferably, but without limitation, classifiers are developed enabling patient stratification through identification of the strength of the molecular mechanism of the therapeutic target. For example, for a gene classifier, assume that the subset of genes that are causally linked to the mechanism and that pass a probe quality filter constitute a feature pool. An algorithm (e.g., a random forest algorithm) is then employed to identify those genes that are best able to identify those patients with a relatively high level of signaling in the area of the therapeutic target. Patients in an independent test set are then classified (e.g., high or low therapeutic target signaling) based on the results of the relative strength calculation of the therapeutic signaling target in relation to the patient group centroid. For a mechanistic classifier, for example, the starting feature pool might include all the possible signaling strengths calculated for the patients that have a calculated specificity of at least a certain value (e.g., 0.05). The individual group of hypothesis strengths that is best able to stratify patients is then identified, e.g., using a weighted voting algorithm and a t-test. Again, patients in an independent test set are then given classes (high or low therapeutic target signaling) based on the results of the relative strength calculation of the therapeutic signaling target in relation to the patient group.

At optional step 408, targetable areas of active biology within the set of patients designated as non-responders may then be identified.

The above example is merely representative, and it is not meant to limit the scope of the disclosed methodology.

### Additional Examples

To test this strategy, a gene expression classifier was generated to predict infliximab (a monoclonal antibody) response in ulcerative colitis (UC). Using the methodology described herein, this classifier was developed without prior knowledge of patient response to the drug, and it was then tested on an independent set of patients where clinical treatment outcomes were known. FIG. 5 illustrates a training set patient stratification that results from applying this methodology. As noted, the approach is used to predict response to therapy by generating a gene expression classifier to identify patients most likely to respond to the TNF (tumor necrosis factor) targeted therapy infliximab, and testing it in a patient population where response to infliximab is known. This example is chosen because two data sets (with baseline gene expression profiling data and response to therapy) are published, providing for training and test data sets. Based on the previously published work, it is hypothesized that patients with high levels of TNF activation were less likely to respond to a TNF targeted therapy. A TNF signaling strength-based classifier is then generated to identify patients with “high” versus “low” TNF pathway activation. To detect TNF signaling in colon, a 256 gene signature extract from publications was culled from the causal knowledge and applied to colon samples from a training set of patients with inflammatory bowel disease. These training set patients were then stratified, along with six healthy control subjects by their individual levels of TNF (see FIG. 5). The healthy controls had the lowest levels of TNF pathway activation, and low levels of activation in treated patients correlated with response, confirming the hypothesis.

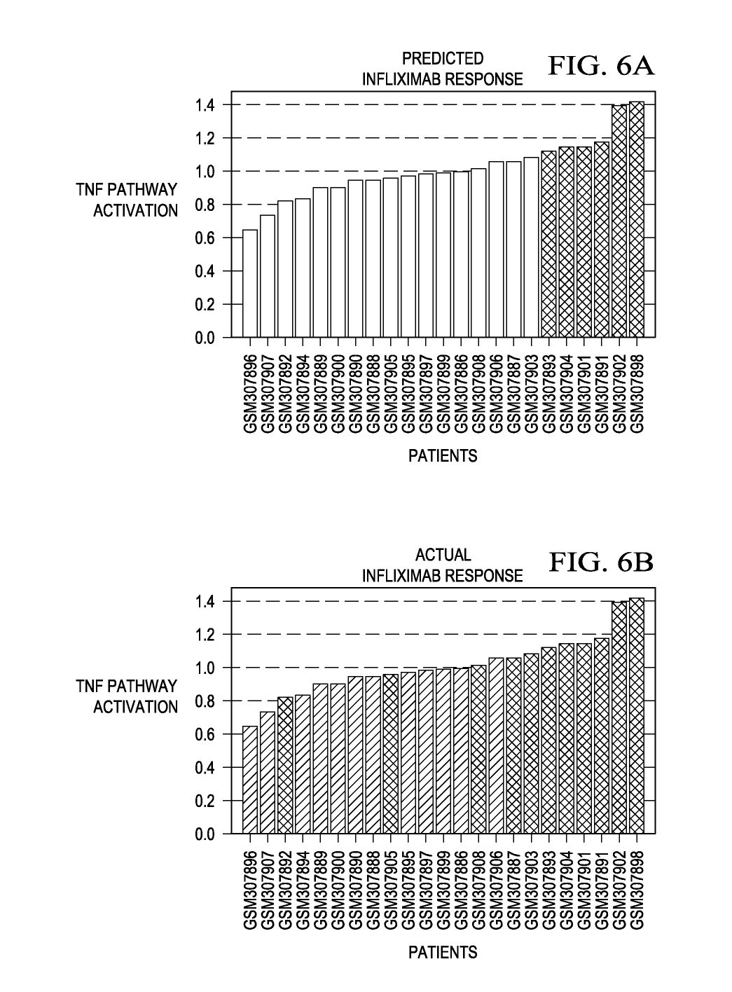

Standard classifier development methods were then applied on data from patients with the highest 20% and lowest 20% TNF activation level to develop a gene classifier. The TNF pathway activation classifier, using detection of TNF pathway amplitude as a surrogate marker of response, performed with a 70% responder predictive value and a 100% non-responder predictive value in an independent test set of patients where outcomes to infliximab were known. This result is shown in FIG. 6. This example (with infliximab in ulcerative colitis) validates how the described approach for patient stratification by disease-driving mechanisms and pathway activation can be used to predict response to a targeted therapy. Once patient populations are identified, biomarkers are generated for each subset driven by a distinct pathway. These biomarkers may then be further developed as a therapeutic diagnostics for selecting appropriate patient populations for entry in clinical trials, or for post-marketing use.

As described above, the techniques herein, in one embodiment, take advantage of known systems and methods for assembling and mining life science data. In particular, it is known to manage and evaluate life science data using a large-scale, specialized, literature-derived knowledgebase of causal biological facts, sometimes referred to as a Knowledge Assembly Model (KAM). A system, method and apparatus of this type are described in commonly-owned U.S. Pat. No. 7,865,534, and U.S. Publication No. 2005/0165594, the disclosures of which are incorporated herein by reference. Familiarity with these known techniques is presumed.

The techniques herein, however, are not limited to signatures derived from a causal knowledge base, as other known techniques may be used to derive the signature. Thus, in the context of one or more disclosed embodiments, the signature is “received” from a source, which source may (but is not required to) be a causal knowledge base.

As used herein, the following terms have the following definitions:

A “knowledge base” is a directed network, preferably of experimentally-observed causal relationships among biological entities and processes;

A “node” is a measurable entity or process;

A “reference node” represents a potential perturbation to a node;

A “signature” is a collection of measurable node entities and their expected directions of change with respect to a reference node;

A “differential data set” is a data set that has data associated with a first condition, and data associated with a second condition distinct from the first condition; and

A “fold change” is a number describing how much a quantity changes going from an initial to a final value, and is specifically computed by dividing the final value by the initial value.

A “classifier” is a set of measurable analytes including, without limitation, RNA expression levels, protein abundance levels, and phospho-protein abundance levels, which can be used to stratify patients into mechanistic biological signaling categories that may be predictive of treatment response. Such classifiers can be used as biomarkers for future identification of responsiveness in additional diseased patients.

An “analyte panel” is a set of measurable analytes including, without limitation, RNA expression levels, protein abundance levels, and phospho-protein abundance levels, which can be used to stratify patients into mechanistic biological signaling categories that may be predictive of treatment response.

A “stratification” is an ordering of patients by strength of specific biological signaling, which may be predictive of treatment response.

A “molecular mechanism” is the activity or effect of a specific biological molecule, entity or process.

A “biomarker” is a method or methodology to determine treatment, including the identification of gene classifiers.

As a shorthand reference, but not by way of limitation, the “degree of activation” computed as described herein is sometimes referred to herein as a “network perturbation amplitude” or “NPA.” As noted above, this disclosure describes several “types” of the degree of activation measure associated with a signature. The first of these types is a “strength” measure, which is a weighted average of adjusted log-fold changes of measured node entities in the signature, where the adjustment applied to the log-fold changes is based on their expected direction of change. As used herein, log refers to log2 or log10. Thus, the “strength” metric quantifies fold-changes of measurements in the signature.

The techniques described herein are implemented using computer-implemented enabling technologies such as described in commonly-owned, co-pending applications U.S. Publication No. 2005/00038608, No. 2005/0165594, No. 2005/0154535, and No. 2007/0225956. These patent applications, the disclosures of which are incorporated herein by reference, describe a causal-based systems biology modeling tool and methodology. In general, this approach provides a software-implemented method for hypothesizing a biological relationship in a biological system that uses a database comprising a multiplicity of nodes representative of biological elements, and relationship descriptors describing relationships between nodes, the nodes and relationship descriptors in the database comprising a collection of biological assertions from which one or more candidate biological assertions are chosen. After selecting a target node in the database for investigation, a perturbation is specified for the target node. In response, given nodes and relationship descriptors of the database that potentially affect or are affected by the target node are traversed. In response to data generated during the traversing step, candidate biological assertions can be identified for further analysis.

Aspects of this disclosure (such as the calculation of the strength metrics) and the stratification of patients may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention. A given machine includes network interfaces and software to connect the machine to a network in the usual manner. The subject matter may be implemented as a standalone product, or as a managed service using a set of machines, which are connected or connectable to one or more networks. More generally, the product or service is provided using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., AJAX technologies, Java applets or servlets, linkable libraries, native code, or the like, depending on platform), that provide the functionality of a given system or subsystem. A display may be used to provide a visual output of the strength metric, the strength values for multiple patients, patient stratification, the literature model, or any other work of authorship described and/or illustrated herein. As described, the product or service may be implemented in a standalone server, or across a distributed set of machines. One or more functions may be carried as using software and as a service (SaaS). Typically, a server connects to the publicly-routable Internet, an intranet, a private network, or any combination thereof, depending on the desired implementation environment.

Having described our invention, what we now claim is as follows.

1. A method of stratifying a set of disease-exhibiting patients prior to clinical trial of a therapy, comprising:
identifying one or more genes that are differentially expressed and can be regulated by the therapeutic target;
assessing therapeutic target signaling strength in individual patients of the set using the one or more genes identified; and
stratifying the set of disease-exhibiting patients according to their therapeutic target signaling strength;
wherein at least one step is implemented in a machine using a hardware element.

2. The method as described in claim 1 wherein the disease-exhibiting patients are stratified along a continuum of therapeutic target signaling strength.

3. The method as described in claim 2 wherein a first subset of patients on the continuum are associated with therapeutic target signaling strength of a first range, the first subset of patients being defined as likely responders to the therapy.

4. The method as described in claim 3 wherein a second subset of patients on the continuum are distinct from the first subset are associated with therapeutic target signaling strength of a second range that is different in value that the first range, the second subset of patients being defined as likely non-responders to the therapy.

5. The method as described in claim 1, wherein the therapeutic target signaling strength is a measure of fold change and direction of genes in a gene signature.

6. The method as described in claim 1, wherein the one or more genes are identified using a molecular footprint.

7. The method as described in claim 6, wherein the molecular footprint is generated by identifying gene expression changes regulated by the therapeutic target in an experimentally-relevant or disease-relevant context.

8. The method as described in claim 7, wherein the gene expression changes are identified from a knowledgebase of gene expression data.

9. The method as described in claim 1, further including identifying gene expression or other data format biomarkers.

10. The method as described in claim 9, further including using the gene expression or other data format biomarkers to identify one or more responder categories in a new set of one or more disease-exhibiting patients.

11. Apparatus, comprising:
a processor; and
computer memory holding computer program instructions to execute a method of pre-clinical trial patient classification, comprising:
stratifying disease-exhibiting patients on a continuum of therapeutic target signaling strength, wherein signaling strength is a measure of fold change and direction of expression of genes in a gene signature; and
based on a stratification of the disease-exhibiting patients along the continuum of therapeutic target signaling strength, identifying gene expression or other data format biomarkers; and
using the gene expression or other data format biomarkers to identify one or more responder categories in a new set of disease-exhibiting patients.

12. The apparatus as described in claim 11, further including a database, the database supporting a knowledgebase of gene expression data.

13. The apparatus as described in claim 11, wherein a first subset of patients on the continuum are associated with therapeutic target signaling strength of a first range, the first subset of patients being defined as likely responders to a therapy.

14. The apparatus as described in claim 13, wherein a second subset of patients on the continuum are distinct from the first subset are associated with therapeutic target signaling strength of a second range that is different in value that the first range, the second subset of patients being defined as likely non-responders to the therapy.

15. A diagnostic method, comprising:
prior to clinical trial, stratifying disease-exhibiting patients based on a measure of therapeutic target signaling strength to generate first and second patient subsets, a first subset defined as likely responders to the therapy, and a second subset defined as likely non-responders to the therapy; and
following stratification of the disease-exhibiting patients, identifying a gene expression or biomarker predictive of one or more patient responder categories in other disease-exhibiting patient populations;
wherein at least one step is implemented in a machine using a hardware element.
